(19) United States
(12) Patent Application Publication
(10) Pub. No.: US 2022/0335675 A1
(43) Pub. Date: Oct. 20, 2022

(54) PHYSICAL PHENOMENA EXPRESSING METHOD FOR EXPRESSING THE PHYSICAL PHENOMEANA IN MIXED REALITY, AND MIXED REALITY APPARATUS THAT PERFORMS THE METHOD

(71) Applicant: ELECTRONICS AND TELECOMMUNICATIONS RESEARCH INSTITUTE, Daejeon (KR)

(72) Inventors: Jin Sung CHOI, Daejeon (KR); Bonki KOO, Daejeon (KR); Yong Sun KIM, Daejeon (KR); Jae Hean KIM, Sejong-si (KR); Byungkuk SEO, Daejeon (KR)

(73) Assignee: ELECTRONICS AND TELECOMMUNICATIONS RESEARCH INSTITUTE, Daejeon (KR)

(21) Appl. No.: 17/525,829

(22) Filed: Nov. 12, 2021

(30) Foreign Application Priority Data
Apr. 20, 2021 (KR) 10-2021-0051015

(51) Int. Cl. G06T 15/00; G06T 15/20; G06T 7/194; G06T 7/11

(52) U.S. Cl. CPC G06T 15/005; G06T 15/20; G06T 7/194; G06T 7/11

(57) ABSTRACT

The present disclosure relates to a mixed phenomena expressing method for expressing physical phenomena in a mixed reality and a mixed reality apparatus for performing the method. To be more specific, the physical phenomena expressing method configures a scene which may enhance a context or a realism to have the same level as the face-to-face situation using a scene configuration of the input image collected from the sensor to provide a service of a mixed reality and a physics/physical property analysis of a target object included in the input image.

### CROSS-REFERENCE TO RELATED APPLICATION

This application claims the benefit of Korean Patent Application No. 10-2021-0051015 filed on Apr. 20, 2021, in the Korean Intellectual Property Office, the entire disclosure of which is incorporated herein by reference for all purposes.

### BACKGROUND

### 1. Field of the Invention

The present disclosure relates to a physical phenomena expressing method for expressing physical phenomena in a mixed reality and a mixed reality apparatus, and more particularly, to a method and an apparatus for simulating and visualizing a physical change in a real space based on a physical property of an actual object in a mixed reality in which virtual information and actual information are mixed.

### 2. Description of the Related Art

The mixed reality is a technique which merges real and virtual worlds to allow a user to interact with an environment in real time by means of a new environment in which actual objects and virtual objects co-exist to experience various digital information more realistically.

A development tool for configuring a mixed reality analyzes the real environment using a camera and an acceleration sensor mounted in a smartphone. In other words, the development tool for configuring the mixed reality scans surrounding environment information using a camera as images and figures out space information such as a floor, a plane, or a ceiling of the real space.

Recently, a technique for realistically placing an object on a floor or a table on a mixed reality by figuring out space information has been developed and a virtual furniture placement application to which the technique is applied has been developed. Further, depth information of an actual space is figured out by a location-based augmented reality game to perform the blending process to reproduce a feeling that a virtual character moves while recognizing a real space.

Further, as a “reality blending” function which figures a shape of an object of a real world and depth information is additionally developed, a Pokémon character hides behind a real object or blocked by trees, or a table which is located in a moving path is recognized as an obstacle.

However, since a mixed reality is created according to the relative perspective between the real object and the virtual environment, there is a problem in that the perspective of the virtual environment is adjusted according to the change in perspective between the user and the real object, so that a mixed reality in which the real environment and the virtual environment are naturally mixed cannot be provided.

### SUMMARY

The present disclosure provides a physical phenomena expressing method which increases immersion by means of simulation and visualization by implementing a scene in which there is no boundary between a virtual world and a real world when a mixed reality is provided to a user by means of a mixed reality apparatus.

The present disclosure provides a physical phenomena expressing method which immediately reflects various physical deformations such as a physical property or physics connected to a target object to a real environment by figuring out whether to be deformed in a situation and an external environmental condition of the target object in consideration of a space and a viewpoint of the user.

According to an aspect of the present disclosure, a physical phenomena expressing method may include determining a target object to be deformed from an input image to implement an autonomous reaction in a mixed reality, generating a 3D shape of the target object by retrieving an edge of the target object based on an angle of a camera which photographs the input image when the target object is determined, deforming the 3D shape of the target object in consideration of an external environment condition according to a physical characteristic of the target object, and visualizing the rendered input image by rendering the deformed 3D shape of the target object to the input image.

The determining of the target object may include determining the target object to be deformed in the input image by considering at least one of a direction, a field of view, and a viewpoint that a user looks in a space where the user is located.

The determining of the target object may include separating a background and a configuration object of a real space applied in the mixed reality from the input image; and determining a target object in which a scene structure of the input image is considered, among the configuration objects.

The generating of the 3D shape of the target object may include generating the 3D shape of the target object by retrieving an edge to which at least one of an appearance and a topology structure of the target object in the input image is reflected based on the angle of the camera.

The deforming of the 3D shape of the target object may include deforming the 3D shape of the target object in consideration of a deformation range for the 3D shape of the target object according to the external environment condition of the input image.

The deforming of the 3D shape of the target object may include deforming a specific part or all of mesh information based on the mesh information representing the 3D shape of the target object in response to the external environment condition of the input image.

The displaying of the rendered input image may include rendering the deformed 3D shape of the target object to the input image in consideration of interference between the mesh information about the deformed 3D shape of the target object and a configuration object included in the input image.

According to another aspect of the present disclosure, a physical phenomena expressing method may include determining a scene structure for a real environment from an input image collected by a sensor to configure a mixed reality; determining a deformable target object in response to an external environment condition based on the determined scene structure; generating a 3D shape of the determined target object and deforming a 3D shape of the target object according to a physical characteristic of the target object; and visualizing a rendered input image by rendering the deformed 3D shape of the target object to the input image.

The determining of the deformable target object may include determining the target object for implementing an autonomous reaction in the mixed reality from the input image in consideration of a characteristic of the target object in a space of the mixed reality.

The deforming of the 3D shape of the target object may include generating the 3D shape of the target object by retrieving an edge to which at least one of an appearance and a topology structure of the target object in the input image is reflected based on an angle of a camera.

The displaying of the rendered input image may include rendering the deformed 3D shape of the target object to the input image in consideration of interference between mesh information about the deformed 3D shape of the target object and a configuration object included in the input image.

According to another aspect of the present disclosure, a mixed reality apparatus includes a processor which is configured to determine a target object to be deformed from an input image to implement an autonomous reaction in a mixed reality; generate a 3D shape of the target object by retrieving an edge of the target object based on an angle of a camera which photographs the input image when the target object is determined; deform the 3D shape of the target object in consideration of an external environment condition according to a physical characteristic of the target object; and visualize a rendered input image by rendering the deformed 3D shape of the target object to the input image.

The processor may determine a target object to be deformed in an input image by considering at least one of a direction, a field of view, and a viewpoint that the user looks in a space where the user is located.

The processor may generate the 3D shape of the target object by retrieving an edge to which at least one of an appearance and a topology structure of the target object in the input image is reflected based on the angle of the camera.

The processor may deform a specific part or all of mesh information based on the mesh information representing a 3D shape of the target object in response to the external environment condition of the input image.

The processor may render the deformed 3D shape of the target object to the input image in consideration of interference between the mesh information about the deformed 3D shape of the target object and the configuration object included in the input image.

According to another aspect of the present disclosure, a mixed reality apparatus includes a processor which is configured to determine a scene structure for a real environment from an input image collected by a sensor to configure a mixed reality, determine a deformable target object in response to an external environment condition based on the determined scene structure, generate a 3D shape of the determined target object, deform the 3D shape of the target object according to the physical characteristic of the target object, and visualize a rendered input image by rendering the deformed 3D shape of the target object to the input image.

The processor may determine a target object for implementing an autonomous reaction in a mixed reality from the input image in consideration of a characteristic of the target object in a space of the mixed reality.

The processor may generate the 3D shape of the target object by retrieving an edge to which at least one of an appearance and a topology structure of the target object in the input image based on the angle of the camera is reflected.

The processor may render the deformed 3D shape of the target object to the input image in consideration of interference between the mesh information about the deformed 3D shape of the target object and the configuration object included in the input image.

According to the example embodiment of the present, a physical phenomena expressing method may enhance immersion by means of simulation and visualization by implementing a scene in which there is no boundary between a virtual world and a real world when a mixed reality is provided to a user by means of a mixed reality apparatus.

According to the example embodiment of the present disclosure, a physical phenomena expressing method may immediately reflect various physical deformations such as a physical property or physics connected to a target object to a real environment by figuring out whether to be deformable in a situation and an external environmental condition of the target object in consideration of a space and a viewpoint of the user.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a view illustrating to explain an overall operation for expressing physical phenomena in an MR environment according to an example embodiment of the present disclosure;

FIG. 2 is a view illustrating to explain a detailed operation of a mixed reality apparatus according to an example embodiment of the present disclosure;

FIG. 3 is a view illustrating to explain an operation of reflecting and visualizing a physical characteristic for an external environment element to a target object according to an example embodiment of the present disclosure;

FIGS. 4A to 4G are views illustrating a detailed process of implementing an autonomous reaction in a mixed reality according to an example embodiment of the present disclosure;

FIG. 5 is a view illustrating to explain a physical phenomena expressing method according to an example embodiment of the present disclosure; and

FIG. 6 is a view illustrating to explain a physical phenomena expressing method according to another example embodiment of the present disclosure.

### DETAILED DESCRIPTION

Hereinafter, example embodiments of the present disclosure will be described in detail with reference to the accompanying drawings.

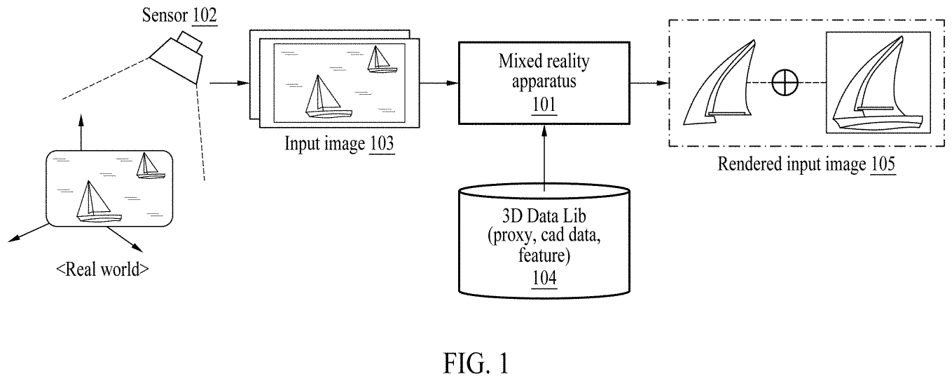

FIG. 1 is a view illustrating to explain an overall operation for expressing physical phenomena in an MR environment according to an example embodiment of the present disclosure.

Referring to FIG. 1, the mixed reality apparatus 101 may configure a scene which may enhance a context or a realism to have the same level as the face-to-face situation in consideration of a physical characteristic of a target object selected from a scene of an input image 103. The mixed reality apparatus 101 may propose a method which performs deformation according to internal information or external information of the target object by applying a data set which considers a deep-learning-based application area to manipulate the real world to perform surreal expression.

The mixed reality apparatus 101 is implemented as a wearable device which is worn on a body of the user and may determine a target object to be deformed in an input image by considering at least one of a direction, a field of view, and a viewpoint that the user looks in a space where the user is located. When the target object is determined, the mixed reality apparatus 101 may determine a target object to be deformed in the input image by 1) a determining method by a user and 2) a determining method by an event in an area of interest.

1) Determining Method by User

In the mixed reality apparatus 101, the target object to be deformed in the input image may be determined by the user. To be more specific, when the user wears a smart phone or glasses and approaches an object of interest while staying in an area of interest, the mixed reality apparatus 101 may determine a target object by picking a specific object using a gaze (recognizable by a camera pose) or a hand gesture on the object of interest.

2) Determining Method by Event in Area of Interest

The mixed reality apparatus 101 may periodically monitor (poll) an event which satisfies a condition allocated thereto in an AOI from an object which autonomously reacts and when an event or a trigger is detected, perform an autonomous reaction mechanism to determine the target object. For example, when it is assumed that the user plays an online-game, the mixed reality apparatus 101 may detect an enemy approaching in a predetermined distance and induce the user to shoot an arrow to determine the target object based on the autonomous reaction mechanism.

Further, the mixed reality apparatus 101 may determine a scene structure according to a type and a material of the target object which configures the input image 103. The mixed reality apparatus 101 may determine a changed position of the target object according to various viewpoints. The mixed reality apparatus 101 may set a size and a shape of the target object included in the input image in consideration of the changed position and a distance of the target object.

When the target object is determined, the mixed reality apparatus 101 may retrieve an edge of the target object based on an angle of a camera which photographs the input image. The mixed reality apparatus 101 may generate a 3D shape of the target object according to the edge of the target object and deform the 3D shape of the target object in consideration of the external environment condition according to a physical characteristic of the target object. The mixed reality apparatus 101 may interwork with a three-dimensional data library (3D data Lib) 104 and render the deformed 3D shape of the target object to the input image to display a rendered input image 105.

The mixed reality apparatus 101 may generate the 3D shape from image sequences (spatio-temporal based) obtained by continuously acquiring the same object or environment information at a plurality of points. Further, according to this method, a current reference image (t=0) and a previous image (t−1) are referenced to generate the target object using correlation (main features in the image).

Accordingly, the mixed reality apparatus 101 may figure out the surrounding environment and the target object with reference to a space and a viewpoint where the user is located and interwork with feature data such as physical property or physics connected to the object to perform simulation according to the immediacy and the visualization which matches according to the viewpoint. For example, when it is assumed that there is a scene in which a virtual glass is placed on a real desk in the mixed reality, in the mixed reality apparatus 101, a situation in which a real passerby collides with the real desk may occur. Therefore, the mixed reality apparatus 101 may reproduce a scene in which the virtual glass is broken due to the collision as if it were real. Thereafter, the mixed reality apparatus 101 may visualize the reproduced scene while maintaining visual consistency without being disconnected at an observation viewpoint of the user.

Therefore, the mixed reality apparatus 101 may simultaneously process the rendering and the composition in real time by reflecting a physical describing method of an autonomous reaction mechanism according to the shape for the target object in the input image 103 input through the sensor 102 and the external environment information (lighting and a camera pose) during the simulation process.

Further, the mixed reality apparatus 101 may be utilized for the e-commerce for immediately reflecting the physical deformation in the real world to the real environment by means of the simulation which reflects the appearance and inherent physics and physical properties of the target object in the mixed reality in which the real and virtual worlds are mixed.

For example, the mixed reality apparatus 101 which is applicable to the e-commerce may induce the purchase decision through the simulation based on a characteristic or a physical property of a product to be purchased beyond the level of placing visual information of the product to be purchased or some virtual products in the real space. By doing this, according to the present disclosure, a return rate by the e-commerce may be significantly lowered. As another example, the mixed reality apparatus 100 which is applicable to the e-commerce may induce the purchase decision in consideration of a weight of a product to be disposed on a glass table to be purchased. As another example, the mixed reality apparatus 100 which is applicable to the e-commerce may restore a three-dimensional appearance of a lighting stand using an input image, figure out the number of joints expressed in the input image by analyzing a feature of the appearance, and thus reflect a mechanical characteristic to change a lighting position.

The present disclosure may be utilized for the e-commerce by composition by an immediate rendering (on the fly) mode of the restoration and deformation of the three-dimensional scene (including restoration and tracking of a specific object) in the situation of the mixed reality. According to the present disclosure, meta data (physical property and material) of the inherent characteristic (physical property and materials) of the deformed object is consistently built by an image-based deep learning to expand an applicable range.

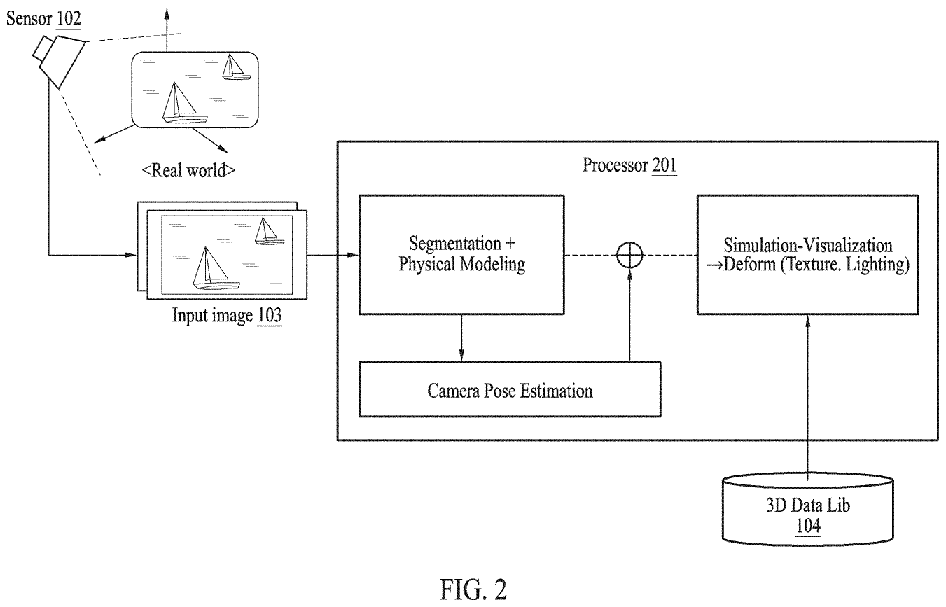

FIG. 2 is a view illustrating to explain a detailed operation of a mixed reality apparatus according to an example embodiment of the present disclosure.

Referring to FIG. 2, the mixed reality apparatus may include a processor 201 and the processor 201 may perform the simulation which reflects the physics/physical property in the mixed reality space. To this end, the processor 201 may generate an input image 103 (or an image sequence) from the real world through various sensors 102 and perform segmentation and 3D-modeling of the target object therefrom. The processor 201 may estimate an angle or a pose of a camera/sensor which photographs the input image. The processor 201 may generate a three-dimensional model using data specified to the deep learning and domain (applied area).

At this time, the processor 201 may utilize data stored in the three-dimensional data library 104 as the reference and store an application field, similar data to the target object, and existing CAD data, and main feature points in the similar data and the CAD data. This is an important feature to perform the transfer based on the easiness of the three-dimensional search and the most-similar data.

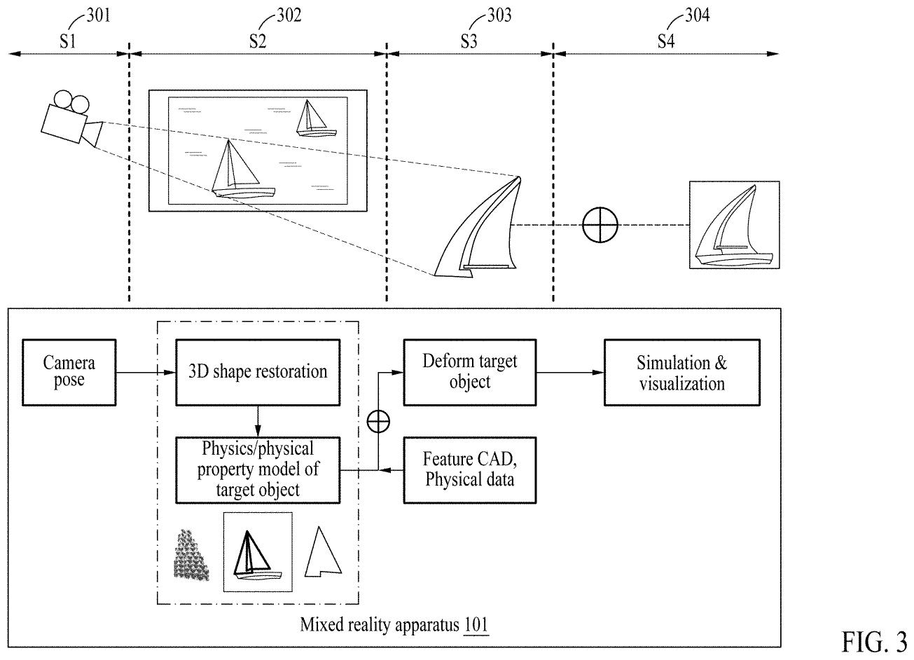

FIG. 3 is a view illustrating to explain an operation of reflecting and visualizing a physical characteristic for an external environment element to a target object according to an example embodiment of the present disclosure.

In S1 (301), the mixed reality apparatus 101 may estimate an angle or a pose of a camera which photographs an input image. The mixed reality apparatus 101 may estimate the angle or the pose of the camera using a distance between the camera and the target object according to the direction, the field of view, and the viewpoint that the user looks in a space where the user is located or a reference point in the input image.

In S2 (302), the mixed reality apparatus 101 may extract a main factor such as an edge of the target object based on the pose of the camera. The mixed reality apparatus 101 may estimate and generate the 3D shape based on the main factor. The mixed reality apparatus 101 may retrieve an edge to which at least one of an appearance and a topology structure of the target object in the input image is reflected based on the angle of the camera to generate the 3D shape of the target object. The mixed reality apparatus 101 may identify a type of the target object and retrieve the physical characteristic of the target object therefrom.

To be more specific, the mixed reality apparatus 101 may identify the type of the target object according to the surrounding background of the input image. This will be represented in Table 1.

TABLE 1

| Input image | Identifiable object category |
|---|---|
| Natural | Mountains (forest, trees, rocks), Sea (water, islands) |
| background | Deserts (soil), Lake (water, flowers), Sky (cloud) |
| Artificial | Building (buildings, apartments, factories, houses, etc.) |
| background | Mobile objects (cars, motorcycles, aircrafts, |
| | bicycles, mobile robots, etc.) |
| | Furniture (desks, chairs, tables, lightings, ornaments, etc.) |
| | Devices (computers, printers, smart phones, etc.) |
| | Equipment (cranes, conveyor belts, CNC machines, |
| | 3D printers, presses, etc.) |
| Others | Human (gender, age, race), Animals (mammal, etc., |
| | distinguished by characteristic of motion) |

The mixed reality apparatus 101 may receive an input image including a natural background, an artificial background, and other various scenes. The mixed reality apparatus 101 may determine an identifiable object category as represented in Table 1, according to the feature of the input image. At this time, the mixed reality apparatus 101 may distinguish a type, a material, a sense of volume, and a contrast of the target object which configure the input image. Here, the material of the target object refers to a texture of a visual or tactile surface of the object and a representative texture may be classified into cloth, steel, wood, glass, and the like. The contrast of the target object may represent the brightness and the darkness of the object according to the direction and the distance of the light applied to the target object and the sense of volume of the target object may represent a sense of volume, weight, and mass as a property of the object. The mixed reality apparatus 101 may determine a scene structure according to the type and the material of the target object which configure the input image 103 and determine the identifiable object category according to the scene structure.

In S3 (303), the mixed reality apparatus 101 may deform the 3D shape of the target object when the external environment condition according to the physical characteristic is satisfied. The mixed reality apparatus 101 may determine the physical characteristic according to the type of the target object. This will be represented in Table 2.

TABLE 2

| Target | Physical characteristic |
|---|---|
| object | (and target analysis for deformation) |
| Building | Material (steel, concrete, plastic, etc.), |
| | geometric property (fixed) |
| Mobile | Material (iron, alloy, aluminum, rubber, etc.), |
| object | geometric property (fixed or movable) |
| Furniture | Material (fabric or leather), mechanism |
| | (joint structure, roller, etc.) |
| Device | Material (plastic, glass, etc.), mechanism |
| | (hinge, dynamic structure, etc.) |
| Equipment | Material (iron, aluminum, plastic, vinyl, etc.), |
| | geometric property (fixed or movable) |
| Human | Joint (skeleton), motion (two legs), hair, skin, etc. |

The mixed reality apparatus 101 may deform the 3D shape of the target object in consideration of the external environment condition according to the physical characteristic of the target object. For example, the mixed reality apparatus 101 may create the external environment element such as a strength of the external wind as an event and deform the target object. Further, the mixed reality apparatus 101 may selectively react only with the corresponding element among various external changes.

In S4 (304), the mixed reality apparatus 101 may interwork with the three-dimensional data library and render the deformed 3D shape of the target object to the input image. The mixed reality apparatus 101 may visualize the rendered input image 105. For example, the mixed reality apparatus 101 may perform the rendering and the composition in consideration of a data format which visualizes a deformation range of a shape of a sail according to the strength and the direction of the external wind and an actual environment element such as a texture and a lighting.

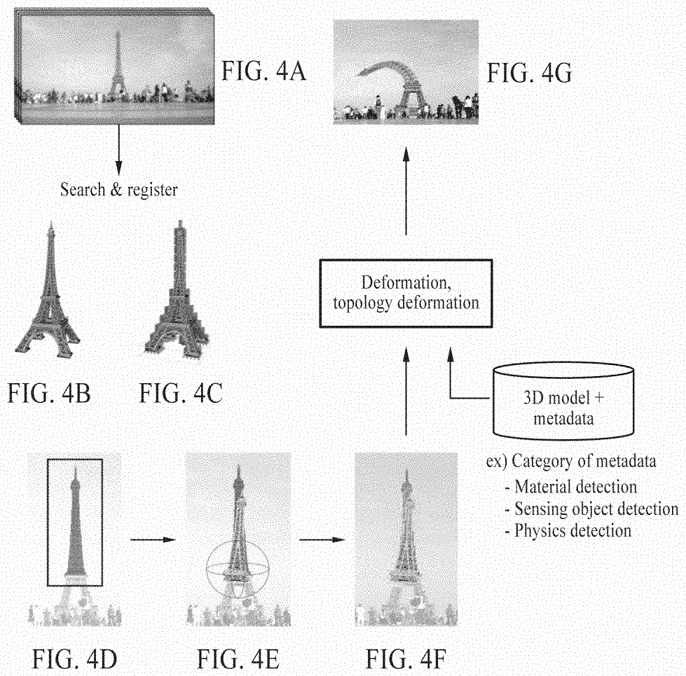

FIG. 4 is a view illustrating a detailed process of implementing an autonomous reaction in a mixed reality according to an example embodiment of the present disclosure.

Referring to FIG. 4, the mixed reality apparatus may implement an autonomous reaction based on a characteristic (physical properties and physics) for the target object in the mixed reality space. For example, the mixed reality apparatus may visualize a situation which generates information using a mobile device such as a smart phone while the user is moving in an actual environment.

Therefore, the mixed reality apparatus may explain a process of deforming a tower included in the input image. When the user selects a target object to be deformed from the input image, the mixed reality apparatus may analyze features (appearance and topology structure) of the target object from the input image. The mixed reality apparatus may retrieve data which is the most similar to or the same as the target object from the three-dimensional CAD data library based on the feature of the target object. The mixed reality apparatus may perform a process of fitting to be fitted to the target image using the retrieved data.

By doing this, the mixed reality apparatus may generate three-dimensional model data and deform the three-dimensional data in response to input by the user or changed external condition. In other words, the mixed reality apparatus may correspond to a process of deforming a specific part of the mesh or the entire mesh together with the mesh corresponding to the appearance of the target object. The mixed reality apparatus may be performed on the premise of restoring and generating of the three-dimensional data and to this end, the mixed reality apparatus preprocesses a process of automatically separating a background and an object from the input image to allow the user to easily designate a specific object.

The mixed reality apparatus may use a method of retrieving and matching the physical characteristic of the object by interworking with the internal/external characteristic database together with the external restoration of the selected target object.

As illustrated in FIG. 4A, the mixed reality apparatus may receive an input image (or image sequences) in the mixed reality situation.

As illustrated in FIGS. 4B and 4C, when the input image is input, the mixed reality apparatus may analyze the input image to perform the rough three-dimensional restoration with respect to the appearance (shape).

As illustrated in FIGS. 4D, 4E, and 4F, the mixed reality apparatus retrieves CAD data from the database built in advance to generate mesh data and fits using the CAD data to generate deformable mesh data for the appearance. The mixed reality apparatus may process to finally visualize how the deformable mesh is deformed by referring to the physical property and physical characteristic during this process.

The mixed reality apparatus may make a database by analyzing a configuration object of a real space which is applied to the mixed reality during this process in advance. Specifically, the mixed reality apparatus may perform data structuration in advance by systematically classifying the object in various categories based on the feature of the input image and linking the CAD data thereof.

Further, the mixed reality apparatus may be utilized for e-commerce for immediately reflecting a physical deformation in the real world to the real environment. To be more specific, according to the present disclosure, the simulation of an operation range according to the joint and an interference with surrounding furniture or space is performed to select an appropriate product. To this end, the mixed reality apparatus analyzes a real space to generate scene structure data configured by all object elements belonging thereto.

Therefore, the present disclosure may propose a method of considering a platform (hardware or software environment) applicable to insert virtual object information about a new product to be purchased into a scene structure in consideration of a process that periodic data update is consistently generated in the background in the mixed reality apparatus.

That is, it means that the mixed reality apparatus needs to consider collision detection to handle the interference between a real physical mesh and a virtual object and the visualization which reflects the physical property. When the mixed reality apparatus implements the above-described method, various special effects (shards of glass splashing while sensing the floor as a virtual glass is broken in the real space) are immediately realized in an augmented reality without post-processing so that an effect of disappearing the boundary between the virtual and real worlds may be obtained. Therefore, according to the present disclosure, in a scene viewed by the user, the target object is immediately deformed/moved/deleted to allow the rendered result to be checked.

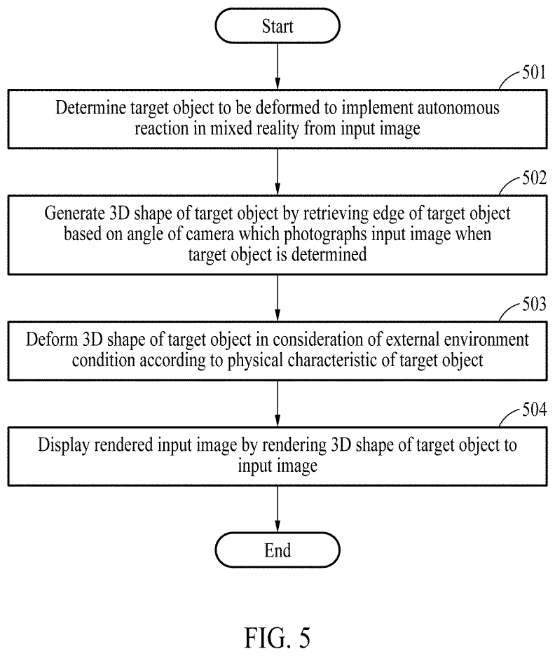

FIG. 5 is a view illustrating to explain a physical phenomena expressing method according to an example embodiment of the present disclosure.

In operation 501, the mixed reality apparatus may determine a target object to be deformed from an input image to implement an autonomous reaction in a mixed reality. The mixed reality apparatus may determine a target object to be deformed in an input image by considering at least one of a direction, a field of view, and a viewpoint that the user looks in a space where the user is located.

At this time, the mixed reality apparatus may separate a background and a configuration object of a real space which is applied in the mixed reality from the input image. The mixed reality apparatus may determine the target object from which a scene structure of the input image is considered, among the configuration objects.

In operation 502, when the target object is determined, the mixed reality apparatus may retrieve an edge of the target object based on an angle of a camera which photographs the input image. The mixed reality apparatus may retrieve an edge to which at least one of an appearance and a topology structure of the target object in the input image is reflected, based on the angle of the camera. Here, the mixed reality apparatus may generate a 3D shape of the target object based on the retrieved edge of the target object.

In operation 503, the mixed reality apparatus may deform the 3D shape of the target object in consideration of the external environment condition according to the physical characteristic of the target object. The mixed reality apparatus may deform the 3D shape in consideration of the deformation range for the 3D shape of the target object according to the external environment condition of the input image. The mixed reality apparatus may deform a specific part, or an entire part of the mesh information based on the mesh information representing the 3D shape of the target object.

In operation 504, the mixed reality apparatus renders the deformed 3D shape of the target object to the input image to display the rendered input image. To be more specific, the mixed reality apparatus performs simulation for estimating a result in the actual situation to render the 3D shape of the target object to the input image. The mixed reality apparatus may render the deformed 3D shape of the target object to the input image in consideration of interference between the mesh information about the deformed 3D shape of the target object and the configuration object included in the input image.

Further, the mixed reality apparatus may perform the rendering by utilizing input image-based view morphing. Further, the mixed reality apparatus may extract a direction and an intensity of a light source from input images photographed by various exposures at one viewpoint. The mixed reality apparatus may render the 3D shape of the target object to the input image by utilizing the direction and the intensity of the light source. The mixed reality apparatus may visualize the rendered input image to actually expose a specific phenomenon to which the physical characteristic is reflected.

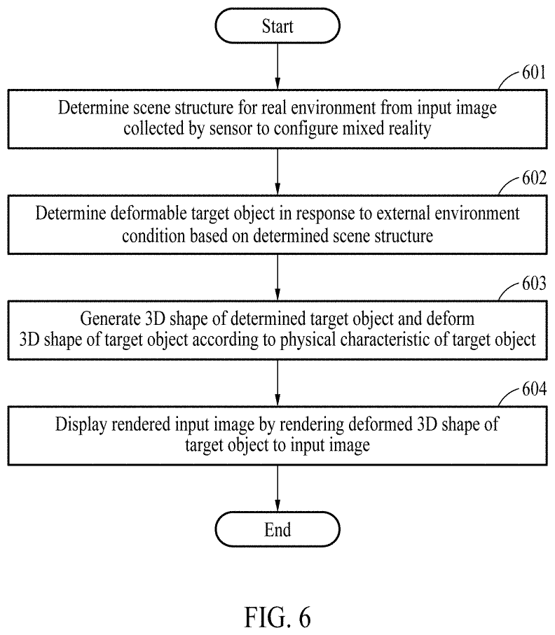

FIG. 6 is a view illustrating to explain a physical phenomena expressing method according to another example embodiment of the present disclosure.

In operation 601, the mixed reality apparatus may determine a scene structure for a real environment from input images collected through a sensor to configure a mixed reality.

In operation 602, the mixed reality apparatus may determine a deformable target object by reflecting the external environment condition based on the scene structure. The mixed reality apparatus may extract a characteristic of the target object existing in the space of the mixed reality from the input image. The mixed reality apparatus may determine the target object to implement autonomous reaction in the mixed reality according to the characteristic of the target object.

In operation 603, the mixed reality apparatus may generate a 3D shape of the determined target object and deform the 3D shape of the target object according to the physical characteristic of the target object. Here, the mixed reality apparatus may retrieve an edge to which at least one of an appearance and a topology structure of the target object in the input image is reflected based on the angle of the camera to generate the 3D shape of the target object. The mixed reality apparatus may deform the 3D shape of the target object in consideration of the deformation range for the 3D shape of the target object.

In operation 604, the mixed reality apparatus may render the 3D shape of the target object to the input image to display the rendered input image. Here, the rendering refers to a process of overlapping a 3D shape or a surface shape of the target object corresponding to an actual object based on the input image to convert the 3D shape or the surface shape to a new input image which is visualized in a mixed reality. For example, the mixed reality apparatus may render a 3D shape of the target object to the input image so as to be looked as a stereoscopic shape based on a two-dimensional planar input image. Here, the higher the quality and a resolution to be utilized for the rendering, the higher the quality of a final content of the input image.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

In the meantime, the method according to the present disclosure is created as a program which is executable in a computer to be implemented as various recording media such as a magnetic storage medium, an optical readable medium, and a digital storage medium.

Various techniques described in the present specification may be implemented by digital electronic circuitry, or computer hardware, firmware, software, or a combination thereof. The implementations may be implemented as a computer program tangibly embodied in a computer program product, that is, an information carrier, for example, a machine readable storage device (computer readable medium) or a radio signal, for example, to perform processing by a data processing device, such as a programmable processor, a computer, or the operation of a plurality of computers, or control the operation. The above-described computer program(s) may be recorded by an arbitrary form of programming language including compiled or interpreted languages and deployed in any form included as a standalone program, or as a module, a component, a sub-routine, or another unit appropriate to be used in a computing environment. The computer program may be deployed to be processed on one computer or a plurality of computers at one site or distributed to a plurality of sites and interconnected by a communication network.

Processors suitable for the processing of the computer program may include both general and special purpose microprocessors and any one or more processors of an arbitrary type of digital computer. Generally, the processor may receive instructions and data from a read only memory and/or a random access memory. Elements of the computer may include at least one processor which executes instructions and one or more memory devices which store the instructions and data. Generally, the computer may include one or more mass storage devices which store data, for example, magnetic, magneto-optic disks, or optical disks or may be coupled thereto to receive data therefrom and/or transmit data thereto. Information carriers suitable to embody computer program instructions and data include, for example, semiconductor memory devices, for example, magnetic media such as a hard disk, a floppy disk, and a magnetic tape, optical media such as a compact disk read only memory (CD-ROM) and a digital video disk (DVD), magneto-optical media such as a floptical disk, a read only memory (ROM), a random access memory (RAM), a flash memory, an erasable programmable ROM (EPROM), and an electrically erasable programmable ROM (EEPROM). The processor and the memory may be supplemented by or included in a special purpose logic circuitry.

Further, the computer readable medium may be an arbitrary available medium accessible by a computer and include both a computer storage medium and a transmission medium.

Although the present specification includes details of a plurality of specific implementations, these are not to be construed as limitations on the scope of any invention or claim, but should rather be construed as a description of features which may be specific to particular embodiments of a particular invention. Specific features described in the present specification in the context of the individual embodiments may be implemented in combination in a single embodiment. In contrast, various features described in the context of the single embodiment may also be implemented in a plurality of embodiments, either individually or in any suitable sub combination. Moreover, although features may operate with a specific combination and may be initially depicted as claimed, one or more features from the claimed combination may be excluded from the combination in some cases and the claimed combination may be modified to a sub combination or a variant of the sub combination.

Likewise, even though the operations are illustrated in the drawings in a particular order, it should not be construed that the operations need to be performed in the particular order or sequentially or all the illustrated operations need to be performed in order to achieve a desirable result. In a specific case, multi-tasking and parallel processing may be advantageous. Further, the separation of various device components of the above-described embodiment should not be construed as requiring the separation in all embodiments and it should be understood that the described program components and devices may be integrated together into a single software product or packaged into a multi-software product.

In the meantime, the example embodiments of the present disclosure disclosed in the specification and the drawing merely propose a specific example for better understanding, but are not intended to limit the scope of the present invention. It is obvious to those skilled in the art that modifications based on the technical spirit of the present disclosure, other than the disclosed example embodiment are allowed.

What is claimed is:

1. A physical phenomena expressing method, comprising:
determining a target object to be deformed from an input image to implement an autonomous reaction in a mixed reality;
generating a 3D shape of the target object by retrieving an edge of the target object based on an angle of a camera which photographs the input image when the target object is determined;
deforming the 3D shape of the target object in consideration of an external environment condition according to a physical characteristic of the target object; and
displaying a rendered input image by rendering the deformed 3D shape of the target object to the input image.

2. The physical phenomena expressing method according to claim 1, wherein
the determining of the target object comprises determining the target object to be deformed in the input image by considering at least one of a direction, a field of view, and a viewpoint that a user looks in a space where the user is located.

3. The physical phenomena expressing method according to claim 1, wherein the determining of the target object comprises:
separating a background and a configuration object of a real space applied in the mixed reality from the input image; and
determining the target object in which a scene structure of the input image is considered, among the configuration objects.

4. The physical phenomena expressing method according to claim 1, wherein the generating of the 3D shape of the target object comprises generating the 3D shape of the target object by retrieving an edge to which at least one of an appearance and a topology structure of the target object in the input image is reflected based on the angle of the camera.

5. The physical phenomena expressing method according to claim 1, wherein the deforming of the 3D shape of the target object comprises deforming the 3D shape of the target object in consideration of a deformation range for the 3D shape of the target object according to the external environment condition of the input image.

6. The physical phenomena expressing method according to claim 1, wherein the deforming of the 3D shape of the target object comprises deforming a specific part or all of mesh information based on the mesh information representing the 3D shape of the target object in response to the external environment condition of the input image.

7. The physical phenomena expressing method according to claim 6, wherein the displaying of the rendered input image comprises rendering the deformed 3D shape of the target object to the input image in consideration of interference between the mesh information about the deformed 3D shape of the target object and a configuration object included in the input image.

8. A physical phenomena expressing method, comprising:
determining a scene structure for a real environment from an input image collected by a sensor to configure a mixed reality;
determining a deformable target object in response to an external environment condition based on the determined scene structure;
generating a 3D shape of the determined target object and deforming the 3D shape of the target object according to a physical characteristic of the target object; and
displaying a rendered input image by rendering the deformed 3D shape of the target object to the input image.

9. The physical phenomena expressing method according to claim 8, wherein the determining of the deformable target object comprises determining the target object for implementing an autonomous reaction in the mixed reality from the input image in consideration of a characteristic of the target object in a space of the mixed reality.

10. The physical phenomena expressing method according to claim 8, wherein the deforming of the 3D shape of the target object comprises generating the 3D shape of the target object by retrieving an edge to which at least one of an appearance and a topology structure of the target object in the input image is reflected based on an angle of a camera.

11. The physical phenomena expressing method according to claim 8, wherein the displaying of the rendered input image comprises rendering the deformed 3D shape of the target object to the input image in consideration of interference between mesh information about the deformed 3D shape of the target object and a configuration object included in the input image.

12. A mixed reality apparatus comprising a processor, wherein the processor is configured to determine a target object to be deformed from an input image to implement an autonomous reaction in a mixed reality, generate a 3D shape of the target object by retrieving an edge of the target object based on an angle of a camera which photographs the input image when the target object is determined, deform the 3D shape of the target object in consideration of an external environment condition according to a physical characteristic of the target object, and display a rendered input image by rendering the deformed 3D shape of the target object to the input image.

13. The mixed reality apparatus according to claim 12, wherein the processor determines the target object to be deformed in the input image by considering at least one of a direction, a field of view, and a viewpoint that a user looks in a space where the user is located.

14. The mixed reality apparatus according to claim 12, wherein the processor generates the 3D shape of the target object by retrieving an edge to which at least one of an appearance and a topology structure of the target object in the input image is reflected based on the angle of the camera.

15. The mixed reality apparatus according to claim 12, wherein the processor deforms a specific part or all of mesh information based on the mesh information representing the 3D shape of the target object in response to the external environment condition of the input image.

16. The mixed reality apparatus according to claim 15, wherein the processor renders the deformed 3D shape of the target object to the input image in consideration of interference between the mesh information about the deformed 3D shape of the target object and a configuration object included in the input image.
